(19) United States
(12) Patent Application Publication
(10) Pub. No.: US 2005/0054225 A1
(43) Pub. Date: Mar. 10, 2005

(54) Press-fit contact for electrical connector

(76) Inventor: Chi Zhang, Kunsan (CN)

Correspondence Address: WEI TE CHUNG;FOXCONN INTERNATIONAL, INC., 1650 MEMOREX DRIVE, SANTA CLARA, CA, 95050, US

(21) Appl. No.: 10/938,077

(22) Filed: Sep. 9, 2004

(30) Foreign Application Priority Data
Sep. 9, 2003 (CN) 03278519.4

(51) Int. Cl. H01R 12/00

(52) U.S. Cl. 439/82

(57) ABSTRACT

A press-fit contact (2) for an electrical connector (1) mounted on a printed circuit board (PCB) (4) to electrically connect different electrical components includes a contacting portion received in the insulative housing (3), a base portion (22) and a retention portion (23) extending downwardly beyond a mounting surface (32) of the housing (3). A pair of elongate channels (231) is defined in the retention portion (23). An elongate support member (234) is formed between the channels (231). A pair of support arms (232) extends upwardly from upper edges of the channels (231). The support arms (232) abut against the mounting surface (32) of the insulative housing (3) for preventing the press-fit contact (2) of the electrical connector from moving upwardly.

### BACKGROUND OF THE INVENTION

1. Field of the Invention

The present invention relates to a contact for an electrical connector, and particularly to a contact for an electrical connector for being press fitted into a corresponding through hole in a printed circuit board (PCB) on which the connector is mounted.

2. Description of Related Art

Two methods are commonly used in the connector field for connecting contacts of an electrical connector to a PCB defining a plurality of though holes for receiving the contacts therein. One method is first to insert tail portions of the contacts into corresponding through holes of the PCB and then solder the tail portions thereto. However, the soldering process is inconvenient and tedious. Therefore, another method, i.e., press-fitting, is more readily applied by manufacturers to facilitate assembly.

As is illustrated in FIG. 5 and FIG. 6, a housing 6 of a conventional connector has a mounting surface 62 facing a PCB 7. A press-fit contact 5 of the conventional connector defines a contacting portion (not shown) received in the housing 6, a base portion 52, and a retention portion 53 extending downwardly from the base portion 52. A hole 531 is defined in a middle of the retention portion 53 and typically has an eye-of-needle shape. A tail portion 533 extends from the retention portion 53 in a direction away from the base portion 52 for leading insertion of the contact 5 into a through hole 71 in the PCB 7. Since the maximum transverse dimension of the retention portion 53 is larger than the diameter of the through hole 71 in the PCB 7, in the process of inserting the contact 5 into the corresponding through hole 71 of the PCB 7, the retention portion 53 of the contact 5 is compressed by inner surfaces of the through hole 71 in the PCB 7, and then tents to restore to its original shape to securely engage with the inner surfaces of the through hole 71. As a result, a mechanical and electrical connection is established between the contact 5 and the PCB 7.

However, one problem with this design is that the press-fit contact 5 with a high retention force typically requires a high insertion force, which results in the risk of upwardly pushing out the press-fit contact 5 from the housing 6 during the insertion of the contact 5 into the through hole 71 of the PCB. Under such condition, the contact 5 will fail to electrically connect well with the PCB and a corresponding contact of a mating connector (not shown).

Therefore, an improved press-fit contact is required to overcome the aforesaid disadvantages of the prior art.

### SUMMARY OF THE INVENTION

Accordingly, an object of the present invention is to provide a press-fit contact having supporting arms for keeping the contact in a correct position when the contact is inserted into a corresponding through hole in a printed circuit board (PCB), thereby ensuring the contact securely engaging with a housing and the PCB.

In order to achieve the objects set forth, a press-fit contact for an electrical connector in accordance with the present invention comprises a contacting portion received in the insulative housing, a base portion and a retention portion extending downwardly beyond a mounting surface of the housing. A pair of parallel, elongate channels is defined in the retention portion. An elongate support member is formed between the channels. A pair of support arms extends outwardly from upper edges of the channels. In use, the support arms abut against the mounting surface of the insulative housing for preventing the press-fit contact of the electrical connector from moving upwardly.

Other objects, advantages and novel features of the invention will become more apparent from the following detailed description when taken in conjunction with the accompanying drawings, in which:

### BRIEF DESCRIPTION OF THE DRAWINGS

FIG. 1 is a perspective view of a printed circuit board (PCB) and a press-fit contact ready to be inserted into a corresponding through hole of the PCB in accordance with a first embodiment of the present invention;

FIG. 2 is a side elevational view of the press-fit contact shown in FIG. 1 inserted into the corresponding through hole of the PCB;

FIG. 3 is a perspective view of a PCB and a press-fit contact ready to be inserted into a corresponding through hole of the PCB in accordance with a second embodiment of the present invention;

FIG. 4 is a side elevational view of the press-fit contact shown in FIG. 3 inserted into the corresponding through hole of the PCB;

FIG. 5 is a perspective view of a printed circuit board (PCB) and a conventional press-fit contact ready to be inserted into a corresponding through hole of the PCB; and

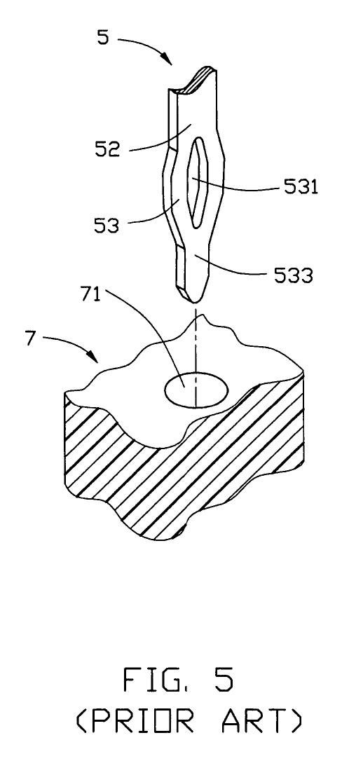

FIG. 6 is a cross-sectional view showing the conventional press-fit contact inserted into the corresponding through hole of the PCB.

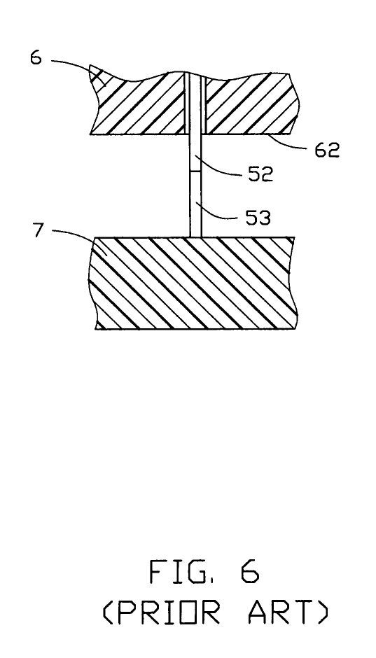

### DETAILED DESCRIPTION OF PREFERRED EMBODIMENTS

Reference will now be made to the drawings to describe the present invention in detail.

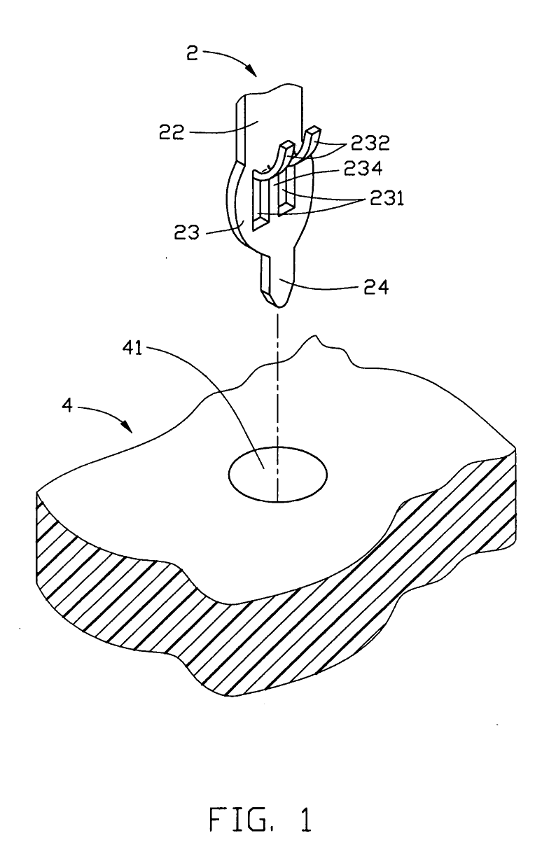

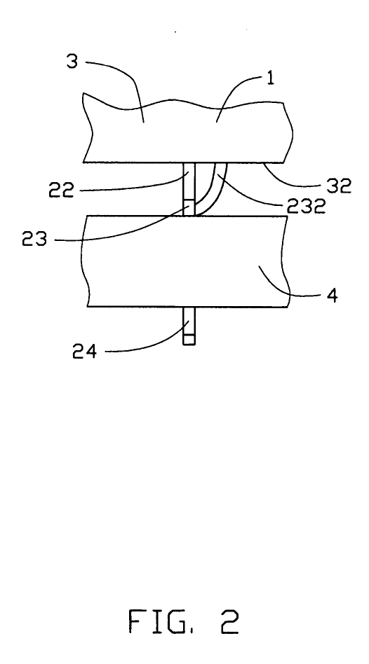

Referring to FIGS. 1 and 2, a press-fit contact 2 for an electrical connector 1 in accordance with a first embodiment of the present invention comprises a contacting portion (not shown) received in an insulative housing 3 of the electrical connector 1, a base portion 22 extending downwardly from the connecting portion beyond a mounting surface 32 of the insulative housing 3 and a retention portion 23 extending downwardly from the base portion 22. The base portion 22 is substantially a flat plate. A pair of parallel, elongate channels 231 is defined in the retention portion 23 and symmetrically located at opposite sides of a longitudinal axis of the press-fit contact 2. An elongate support member 234 is formed between the channels 231 and extends along the longitudinal axis of the press-fit contact 2. A tail portion 24 extends form the retention portion 23 in a direction away from the base portion 22 for facilitating inserting the press-fit contact 2 into a through hole 41 in a printed circuit board (PCB) 4. The retention portion 23 is formed with a pair of support arms 232 stamped therefrom. The support arms 232 extend upwardly from upper edges of the channels 231, respectively, forming a curved connection portion (not labeled) connecting with said upper edge of the channel 231.

In assembly, the contacting portion of the press-fit contact 2 is received in the insulative housing 3, and the support arms 232 upwardly abut against the mounting surface 32 of the insulative housing 3. In the process of inserting the press-fit contact 2 into the through hole 41 defined in the PCB 4, the retention portion 23 of the contact 2 is subjected to an upward force, which may cause a relative movement between the contact 2 and the insulative housing 3. Nevertheless, the support arms 232 tightly abut against the mounting surface 32 of the housing 3 for resisting the contact 2 from moving upwardly with respect to the housing 3, thereby securely retaining the press-fit contact 2 in the insulative housing 3. As a result, a reliable mechanical and electrical connection is established between the press-fit contact 2 and the PCB 4.

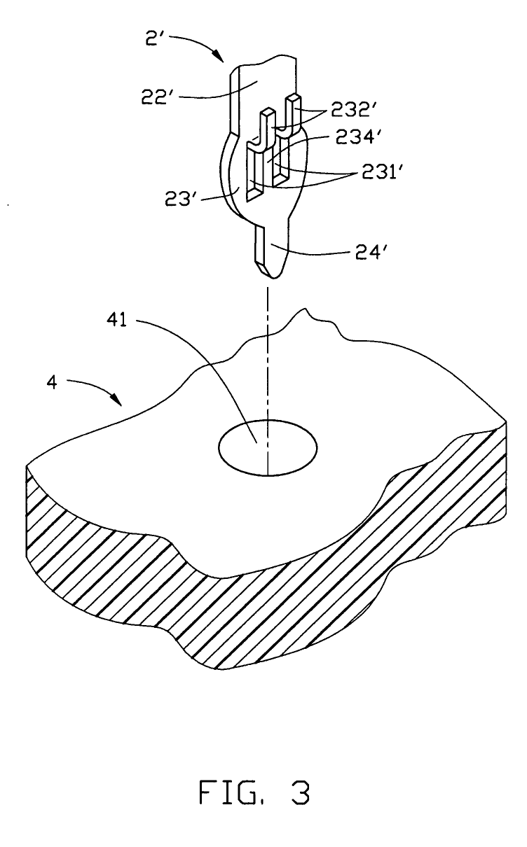

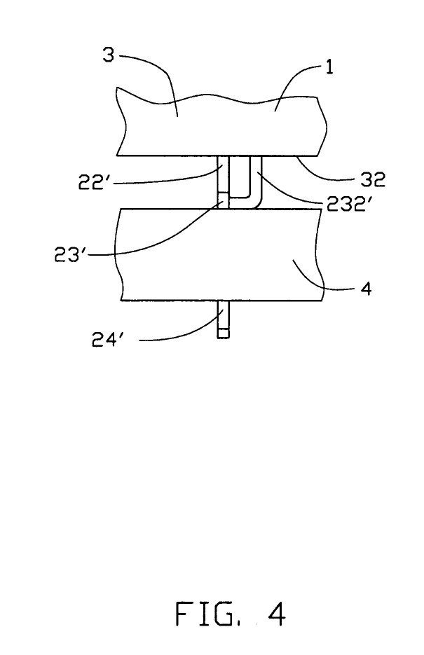

Referring to FIGS. 3 and 4, a press-fit contact 2′ for an electrical connector 1 in accordance with a second embodiment of the present invention is shown. The press-fit contact 2′ is almost the same as the one of the first embodiment except for the shape of the support arms. The support arm 232′ of the press-fit contact 2′ in accordance with the second embodiment first extends outwardly for a little distance form an upper edge of a corresponding channels 231′ and then extends upwardly to be parallel to the base portion 22′.

Compared with the second embodiment, the first embodiment may be used with the retention portion having a less lengthwise dimension, because the obliquely extension may take less material along said lengthwise direction of the retention portion than the L-shaped extension while still reaching the underside of the housing.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A press-fit contact for an electrical connector comprising:
a contacting portion adapted for being received in an insulative housing of the electrical connector;
a base portion extending downwardly from the contacting portion; and
a retention portion extending downwardly from the base portion, the retention portion comprising a pair of channels, a support member formed between the channels and a pair of support arms extending upwardly from upper edges of the channels adapted for upwardly abutting against the housing.

2. The press-fit contact as claimed in claim 1, further comprising a tail portion extending along a longitudinal axis of the contact from the retention portion in a direction away from the base portion.

3. The press-fit contact as claimed in claim 1, wherein the support member extends along a longitudinal axis of the press-fit contact.

4. The press-fit contact as claimed in claim 1, wherein the channels are symmetrically located at opposite sides of a longitudinal axis of the press-fit contact.

5. The press-fit contact as claimed in claim 4, wherein the support arms are parallel to and symmetric with each other.

6. The press-fit contact as claimed in claim 1, wherein the support arm has a curved connection portion connecting with the upper edge of the channel.

7. The press-fit contact as claimed in claim 1, wherein the support arms first extend outwardly and then extend upwardly to be parallel to the base portion.

8. A press-fit contact for an electrical connector comprising:
a contacting portion adapted for being received in an insulative housing of the electrical connector;
a base portion extending downwardly from the contacting portion; and
a retention portion extending downwardly from the base portion, the retention portion defining a channel with a support arm extending upwardly from an upper edge of the channel; wherein
a tip of the support arm abuts against an underside of the housing for reinforcement consideration, and said support arm essentially extends in an oblique direction so that an intersection angle between the retention portion and the support arm is an acute angle.
